(19) United States
(12) Patent Application Publication
(10) Pub. No.: US 2015/0022221 A1
(43) Pub. Date: Jan. 22, 2015

(54) DIRECTIONAL CAPACITIVE SENSING MEANS

(71) Applicant: CHING-YEN HSU, New Taipei City (TW)

(72) Inventor: CHING-YEN HSU, New Taipei City (TW)

(21) Appl. No.: 14/331,240

(22) Filed: Jul. 15, 2014

(30) Foreign Application Priority Data
Jul. 16, 2013 (TW) 102125454

(51) Int. Cl. G01B 7/004; G01B 7/30; G01N 27/22

(52) U.S. Cl. CPC G01B 7/004; G01N 27/22; G01B 7/30
USPC 324/658

(57) ABSTRACT

A directional capacitive sensing means for sensing number, size, position and motion direction and/or speed of sensing objects, which comprises two or more proximity capacitive sensing means, an analysis means, the two or more proximity capacitive sensing means are arranged in two or more different positions that resulted in two or more sensing fields being formed, whereof a combination area forms a sensing space; the proximity capacitive sensing devices individually produce. an electric charge sensing information according to a change of the electric charge in the electric charge fields corresponding to sensed objects; the analysis means, which connects the proximity capacitive sensing means for receiving the electric charge sensing information, analyzes a directional information according to changes of distribution of the electric charge fields and strength of the corresponding electric charge sensing information; the directional information comprises number, size, motion direction and/or seed of the sensed objects.

### FIELD OF THE INVENTION

The present invention relates generally to design of auto sensing means, more particularly to directional capacitive sensing means.

### BACKGROUND OF THE INVENTION

With advances in technologies, many sensing technologies nave been developed for life conveniences to sense action of users. For example, there are automatic faucets, automatic doors or anti-theft devices and the like. These auto sensing devices adopt infrared induction technologies. The infrared induction technologies of prior arts have two types: an active infrared induction technology and a passive infrared induction technology. The active infrared induction technology is to emit the infrared ray from s infrared transmitter. When a user passed through the path where the infrared ray is transmitted, the infrared ray will be obstructed by the user that resulted in the infrared ray receiver will only sense the user instead of receiving the infrared ray. The passive infrared induction technology is to detect thermal radiation infrared ray from the human body.

However, the infrared transceivers of the active infrared induction technology are need to have high energy consumption in continuously transmitting and detecting, infrared rays, moreover, the function of the devices is only used to sense the users, it cannot sense distance from or position of the users, as well as the path or speed of the users. Particularly, the anti-theft system still has blind angle even if it has many infrared ray sensors. The anti-theft system may loss effectiveness by evading the infrared ray sensors. The passive infrared induction technology is to detect the temperature, so wrong judgment may easily occur when environment temperature changes. Thus the applicable fields are limited.

### SUMMARY OF THE INVENTION

From this, the invention intends to provide a directional capacitive sensing means for sensing position, motion direction and/speed of users to increase efficiency for users.

The technical problem to be solved by the utility model is to overcome defects of the prior art, which is a directional capacitive sensing means for sensing number, size, position and motion direction and/or speed of sensed objects, which comprises two or more proximity capacitive sensing means, which produce two or more electric charge sensing fields, whereof a combination area forms a sensing space; the proximity is capacitive Sensing means individually produce an electric charge sensing information according to a change of the electric charge in the electric charge sensing fields corresponding to sensed objects; and an analysis means, which connects the proximity capacitive sensing means for receiving the electric charge sensing information, the analysis means analyzes a directional information according to changes of distribution of the electric charge sensing fields and strength of the corresponded electric charge sensing information; said directional information comprises number, size, motion direction and/or speed of the sensed objects.

In one embodiment of this aspect, wherein the electric charge sensing fields are provided with an intersection sensing space being formed by more than one intersection areas.

In one embodiment of another aspect, wherein the electric charge sensing fields of the proximity capacitive sensing means are provided with different or adjustable sensitivity.

In one embodiment of another aspect, wherein the electric charge sensing fields of the proximity capacitive sensing means are provided with different or variable-phase polarity.

In one embodiment of yet another aspect, wherein the electric charge sensing fields of the proximity capacitive sensing means are provided with opposite polarity.

In one embodiment of yet another aspect, wherein the electric charge sensing fields of the proximity capacitive sensing means are conjugated.

In yet another aspect, one embodiment of the invention is further provided with a response means, which connects the analysis means to analyze the directional information for action.

In one embodiment of yet another aspect, wherein the response means is a flushing device for bathroom.

In one embodiment of yet another aspect, wherein the response means is an anti-theft device.

A directional capacitive sensing means according to claim 7, wherein the response means is a polarity switch device.

By adopting the above improvement of the technical scheme, as two or more proximity capacitive sensing, means for sensing number, size, position and motion direction and/or speed of sensed objects, which provides no sensing blind angle and the effect of right judgment, besides, the invention adopts proximity capacitive sensing means, which not only can save more energy and apply for everywhere, but also can sense the users body temperature, metal, plastic, liquid, or wood and the like, the utility model has increased the practicality of automatic sensing device.

The invention will now be described in connection with certain preferred embodiments with reference to the following illustrative figures so that it may be more fully understood.

### BRIEF DESCRIPTION OF THE DRAWINGS

FIG. 1 is a front schematic view according to the first embodiment of the present invention;

FIG. 2 is a perspective schematic view according to the second embodiment of the present invention;

FIG. 3 is a schematic view showing a plane electric charge of sensing field according to the second embodiment of the present invention;

FIG. 4 is a side schematic view according to the third embodiment of the present invention.

### DETAILED DESCRIPTION OF THE INVENTION

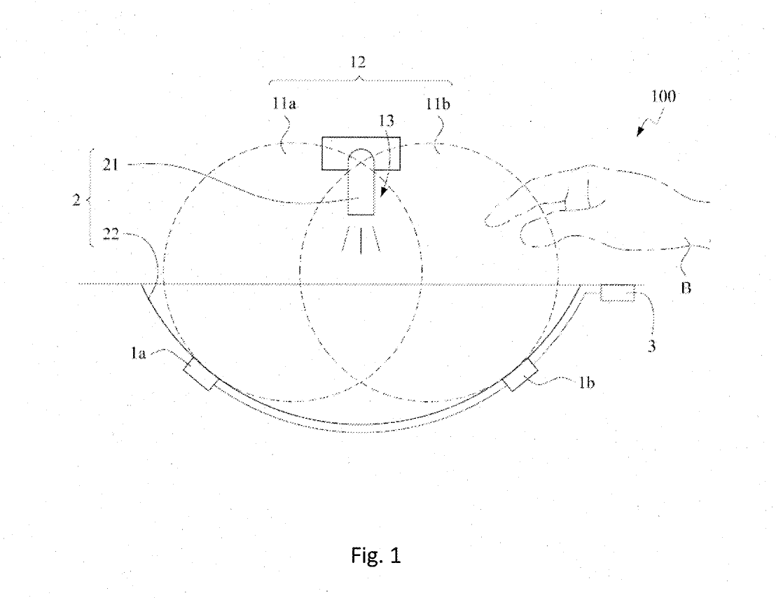

The FIG. 1 shows the schematic diagram of directional capacitive sensing means (100) in the first embodiment. It comprises two proximity capacitive sensing means (1a) and (1b), a response means (2) and an analysis means (3).

In this embodiment, the response means (2) is a bathroom flushing device which comprises a solenoid valve (21) and a wash basin (22). The two proximity capacitive sensing means (1a) and (1b) are disposed on the two sides of the wash basin (22), and generate electric charge field (11a) and (11b), which polarity is adjustable and different. After adjustment, the sensing sensitivity is different. The electric charge sensing fields generated by the proximity capacitive sensing means are externally diffused and cover the space beyond several centimeters and several meters. In the embodiment, the two charge sensing fields (11a) and (11b) form a sensed space (12) which covers the space which the wash basin (22) can accommodate. The sensed space (13) comprising of the intersection covers the space adjacent to outlet of the faucet (21) with a solenoid valve. When the sensed B enters electric charge sensing fields (11) and (11b), the to charge fields (11a) and (11b) change because the sensed B has electric charges, and the two proximity capacitive sensing means (1a) and (1b) generate electric charge sensing information through charge sensing fields (11a) and (11b). The electric charge sensing information strength represents distance from two proximity capacitive sensing means (1a) and (1b). Next, one proximity capacitive sensing means only senses distance between the sensed B and the proximity capacitive sensing means which senses the B, and thus it cannot judge direction of the sensed B to the proximity capacitive sensing means. The two proximity capacitive sensing means can analyze more accurate horizontal position, and horizontal motion speed and/or direction of the sensed B in terms of the relative distance of the sensed B to the two proximity capacitive sensing means after trigonometric function operation, and the position analysis method is similar with GPS. Thus, position and motion direction and/or speed of the sensed B can be accurately sensed by two or more proximity capacitive sensing means. In addition, when several sensed objects enter the sensed space, several electric charges may change in the sensed space where the capacitive sensing means can sense number of sensed objects, and size of the sensed objects according to the electric charge change which may change the occupied space of the sensed objects.

The analysis means (3) is connected with the two proximity capacitive sensing means (1a) and (1b) to receive the electric charge sensing information generated from the means. The analysis means (3) analyzes quantity, size, position, Motion direction and/or speed and other directional information of the sensed B according to the electric charge sensing information strength. First,, when the sensed object B enters one of the two electric charge sensing fields (11a) and (11b), and does not enter the sensed space (13) where the two electric charge sensing fields (11a) and (11b) intersect, the analysis means (3) can analyze relative distance of the sensed B to the proximity capacitive sensing means (1a) or (1b) according to the electric charge sensing information transmitted by the proximity capacitive sensing means (1a) or (1b). Second, when the sensed B enters the sensed space (13) where the two electric charge sensing fields (11a) and (11b) intersect, the analysis means (3) can analyze the distance of the sensed object B to the two proximity capacitive sensing means (1a) and (1b) according to electric charge sensing information transmitted by the two proximity capacitive sensing means (1a) and (1b). At last, the analysis means (3) analyzes directional information of the sensed object. B according to the distance of the sensed object B to the two proximity capacitive sensing means (1a) and (1b), and the directional information contains the sensed object B first passing through one of the two electric charge sensing fields (11a) and (11b) and then the sensed space (13) where the electric charge sensing fields (11a) and (11b) intersect At this time, the faucet (21) with solenoid valve is initiated for flushing according to the directional information. In other case, if the two electric charge sensing fields (11a) and (11b) make the two proximity capacitive sensing means (1a) and (1b) generate the electric charge sensing information at the same time due to vibration, and the directional information analyzed by the analysis mechanism is different from action contents, water flushing will not be performed.

The proximity capacitive sensing means are not affected by the environment temperature, and further they can save electricity, in addition, the invented proximity capacitive sensing means may have misjudgment due to vibration of the sensed space, such as earthquake or humidity change of the sensed space. In the first embodiment herein, the directional capacitive sensing means (100) can make the analysis means (3) judge presence of the sensed B and correctness of action of the sensed object B through intersection of the two electric charge fields (11a) and (11b) to solve misjudgment of the proximity capacitive sensing means,

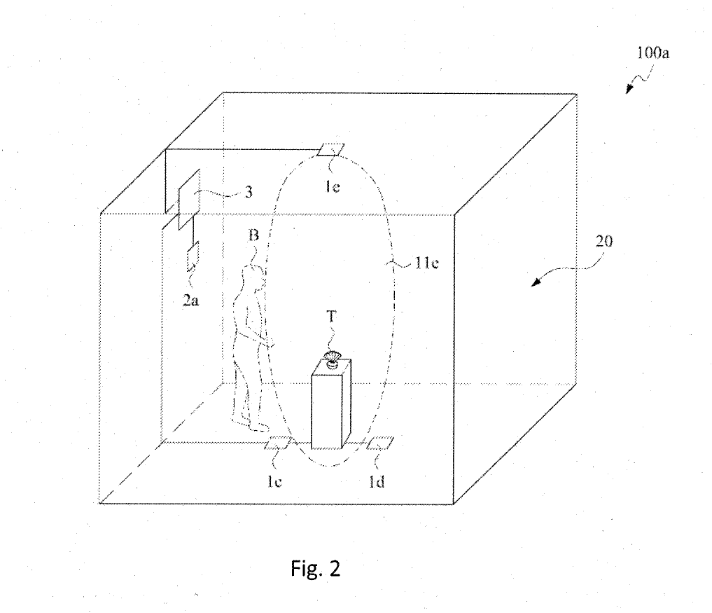

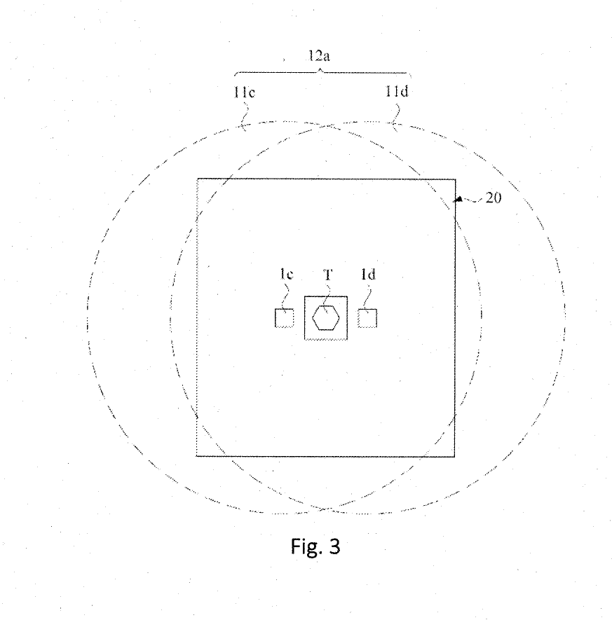

As shown in the FIG. 2 and FIG. 3, the difference between the directional capacitive sensing means (100a) in the second embodiment is different from the directional capacitive sensing means (100) in the first embodiment. The directional capacitive sensing means (100) a in the second embodiment has three proximity capacitive sensing means (1c), (1d) and (1e), and its response means (2a) is anti-theft device, such as an alarm. In the embodiment, the proximity capacitive sensing means (1c) and (1d) are located at the two different positions of floor. The polarity of electric: charges (11c) and (11d) is diffused towards the Ceilings [not illustrated], and the sensed space (12ₐ) where the electric fields (11c) and (11d) meet covers a protected space (20). The proximity capacitive sensing means (1e) is arranged on the ceiling above the protected object T, and the polarity of the electric charge field (11e) is opposite to the proximity capacitive sensing means (1c) and (1d), and is diffused towards the floor and the protected object. The two electric charge fields (11c) and (11d) have sensitivity which is closer to the proximity capacitive sensing means (1e), and have greater sensed space but lower precision. Only large object can be sensed, and the precision of sensing object motion is also lower,

When the sensed object B enters the protected space (20), the analysis means (3) used electric charge sensing information of the two electric charge fields (11c) and (11d) to analyze horizontal distance of the sensed object B to the protected object T [as shown in FIG. 3]. However, after the sensed object B enters the space covered by the electric field (11e) of the proximity capacitive sensing means (1e), the analysis means (3) can obtain accurate electric charge sensing information due to high sensitivity of electric charge field (11e) of the proximity capacitive sensing means (1e), and small motion can be sensed accurately, such as the distance of hand from the protected T can be accurate to centimeters, The analysis means (3) can obtain directional information via the above technique. When the sensed object B enters the protected space (20), the alarm will not be triggered. When the sensed object B enters the space covered by the electric field (11e) of the proximity capacitive sensing means (1e), the anti-theft device issues notice to security personnel for prompt. The alarm will sound when the sensed object B starts to come near to the protected object T within 10 cm. As a result, no blind angle will occur in sensing.

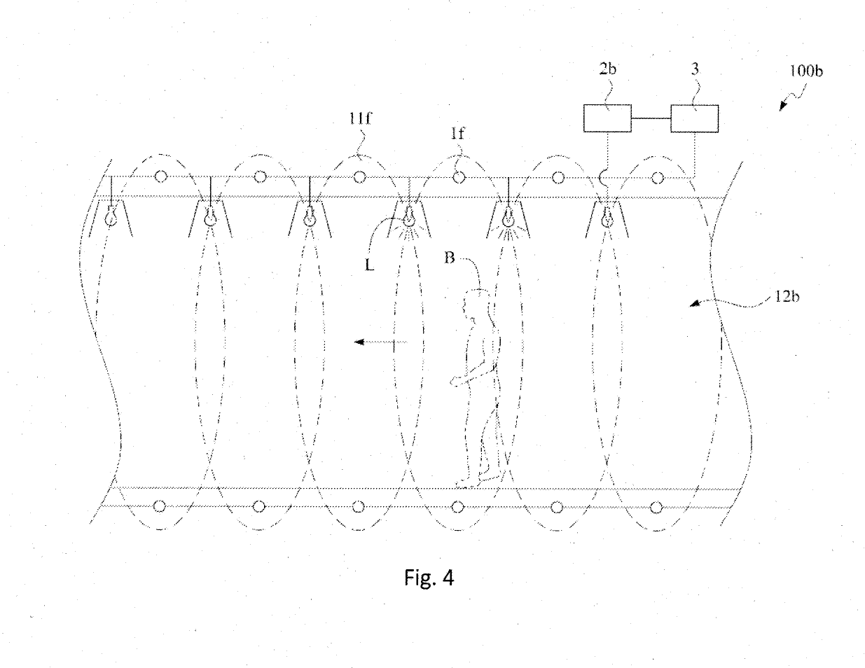

As shown in FIG. 4, as compared to the above embodiments, the directional capacitive sensing means in the third embodiment has more proximity capacitive sensing means (1f) and the response means (2b) as polarity switch. The sensitivity of the electric charge field (11f) of the proximity capacitive sensing means (1f) is adjustable, and can be used in various places. The electric field (11f) of two proximity capacitive sensing means (1f) [top and bottom] is conjugated to increase sensing accuracy. in this embodiment, the directional capacitive sensing means (100b) applied to corridor lights. When the sensed object B walks from one end to the other end of the corridor sensed space (12b), the polarity switch is triggered to turn on the front light L and turn off the rear light L according to path, speed and direction of the sensed object B. This invention is nor limited to this. The polarity switch can be used in acoustics design or electric curtain, in conjunction with proximity capacitive sensing means to sense the sensed object. The invented directional capacitive sensing means can solve the present disadvantages, save electricity and can be used in various places. It has no blind angle and may not have misjudgment in sensing.

1. A directional capacitive sensing means for sensing number, size, position and motion direction and/or speed of sensed objects, which comprises:
two or more proximity capacitive sensing means, which produce two or more electric charge sensing fields, whereof a combination area forms a sensing space; the proximity capacitive sensing means individually produce an electric charge sensing information according to a change of the electric charge in the electric charge sensing fields corresponding to sensed objects; and
an analysis means, which connects the proximity capacitive sensing means for receiving the electric charge sensing information, the analysis means analyzes a directional information according to changes of distribution of the electric charge sensing fields and strength of the corresponded electric charge sensing information; said directional information comprises number, size, motion direction and/or speed of the sensed objects.

2. A directional capacitive sensing means according to claim 1, wherein the electric charge sensing fields are provided with an intersection sensing space being formed by more than one intersection areas.

3. A directional capacitive sensing means according to claim 1, wherein the electric charge sensing fields of the proximity capacitive sensing means are provided with different or adjustable sensitivity.

4. A directional capacitive sensing means according to claim 1, wherein the electric charge sensing fields of the proximity capacitive sensing means are provided with different or variable-phase polarity.

5. A directional capacitive sensing means according to claim 4, wherein the electric charge sensing fields of the proximity capacitive sensing means are provided with opposite polarity.

6. A directional capacitive sensing means according to claim wherein the electric charge sensing fields of the proximity capacitive sensing means are conjugated.

7. A directional capacitive sensing means according to claim 1 is further provided with a response means, which connects the analysis means to analyze the directional information for action.

8. A directional capacitive sensing Means according to claim 7, wherein the response means is a flushing device for bathroom.

9. A directional capacitive sensing means according to claim 7, wherein the response means is an anti-theft device.

10. A directional capacitive sensing means according to claim 7, wherein the response means is a polarity switch device.
